(19) United States
(12) Patent Application Publication
(10) Pub. No.: US 2019/0394379 A1
(43) Pub. Date: Dec. 26, 2019

(54) AUTO EXPOSURE CONTROL PREDICTIVE CONVERGENCE

(71) Applicant: QUALCOMM Incorporated, San Diego, CA (US)

(72) Inventors: Loic Francois Segapelli, San Diego, CA (US); Wei-Chih Liu, Taipei City (TW); Tai-Hsin Kiu, Hsinchu (TW)

(21) Appl. No.: 16/015,034

(22) Filed: Jun. 21, 2018

(51) Int. Cl. H04N 5/235

(52) U.S. Cl. CPC H04N 5/2353

(57) ABSTRACT

Methods, systems, and devices for image processing are described. The method includes capturing from a sensor a first image frame using an initial exposure length, calculating, based on a clipping status of a set of one or more pixels of the first image frame, a predicted exposure length and a hedged exposure length, where the predicted exposure length is different from the hedged exposure length by at least a threshold, capturing from the sensor a first array of pixels using the predicted exposure length and a second array of pixels using the hedged exposure length, capturing from the sensor a second image frame using a converged exposure length, where the converged exposure length is based on a comparison of a saturation of the first array of pixels to a saturation of the second array of pixels, and outputting the second image frame.

### BACKGROUND

The following relates generally to image processing, and more specifically to auto exposure control (AEC) predictive convergence.

In some cases, a device, such as a cell phone, a computer, a laptop, or the like, may include a camera. Image capture devices such as cameras may capture images having a long or a short exposure, and the exposure may define the brightness of the captured image. Such devices may apply an auto exposure algorithm that adjusts an exposure to a reasonable level within an available pixel range.

In some cases, a captured image may have a dynamic range of lighting that exceeds an available pixel range of the capturing device. A device may utilize two or more exposures, which may be merged or combined to generate a reconstructed final image. When a scene changes, exposure in a device such as a camera may need some time to adjust. Adjusting exposure may take a large amount of time. For example, when an image is overexposed or underexposed in a first frame, resulting in pixel saturation, an algorithm may be utilized to decrease exposure in the second frame. However, when pixels clip to pure white or black, an image capturing device may not know by how much to decrease or increase the exposure to capture the image at an ideal exposure length. Thus, several iterations of the algorithm may occur before converging on the ideal exposure. This may result in decreased user experience and unnecessary decrease in the quality of an image.

### SUMMARY

The described techniques relate to improved methods, systems, devices, and apparatuses that support auto exposure control (AEC) predictive convergence. Generally, the described techniques provide for capturing from a sensor a first image frame using an initial exposure length, calculating, based on a clipping status of a set of one or more pixels of the first image frame, a predicted exposure length and a hedged exposure length, where the predicted exposure length is different from the hedged exposure length by at least a threshold, capturing from the sensor a first array of pixels using the predicted exposure length and a second array of pixels using the hedged exposure length, capturing from the sensor a second image frame using a converged exposure length, where the converged exposure length is based on a comparison of a saturation of the first array of pixels to a saturation of the second array of pixels, and outputting the second image frame.

A method of image processing at a device is described. The method may include capturing from a sensor a first image frame using an initial exposure length, calculating, based on a clipping status of a set of one or more pixels of the first image frame, a predicted exposure length and a hedged exposure length, where the predicted exposure length is different from the hedged exposure length by at least a threshold, capturing from the sensor a first array of pixels using the predicted exposure length and a second array of pixels using the hedged exposure length, capturing from the sensor a second image frame using a converged exposure length, where the converged exposure length is based on a comparison of a saturation of the first array of pixels to a saturation of the second array of pixels, and outputting the second image frame.

An apparatus for image processing at a device is described. The apparatus may include a processor, memory in electronic communication with the processor, and instructions stored in the memory. The instructions may be executable by the processor to cause the apparatus to capture from a sensor a first image frame using an initial exposure length, calculate, based on a clipping status of a set of one or more pixels of the first image frame, a predicted exposure length and a hedged exposure length, where the predicted exposure length is different from the hedged exposure length by at least a threshold, capture from the sensor a first array of pixels using the predicted exposure length and a second array of pixels using the hedged exposure length, capture from the sensor a second image frame using a converged exposure length, where the converged exposure length is based on a comparison of a saturation of the first array of pixels to a saturation of the second array of pixels, and output the second image frame.

Another apparatus for image processing at a device is described. The apparatus may include means for capturing from a sensor a first image frame using an initial exposure length, calculating, based on a clipping status of a set of one or more pixels of the first image frame, a predicted exposure length and a hedged exposure length, where the predicted exposure length is different from the hedged exposure length by at least a threshold, capturing from the sensor a first array of pixels using the predicted exposure length and a second array of pixels using the hedged exposure length, capturing from the sensor a second image frame using a converged exposure length, where the converged exposure length is based on a comparison of a saturation of the first array of pixels to a saturation of the second array of pixels, and outputting the second image frame.

A non-transitory computer-readable medium storing code for image processing at a device is described. The code may include instructions executable by a processor to capture from a sensor a first image frame using an initial exposure length, calculate, based on a clipping status of a set of one or more pixels of the first image frame, a predicted exposure length and a hedged exposure length, where the predicted exposure length is different from the hedged exposure length by at least a threshold, capture from the sensor a first array of pixels using the predicted exposure length and a second array of pixels using the hedged exposure length, capture from the sensor a second image frame using a converged exposure length, where the converged exposure length is based on a comparison of a saturation of the first array of pixels to a saturation of the second array of pixels, and output the second image frame.

Some examples of the method, apparatuses, and non-transitory computer-readable medium described herein may further include operations, features, means, or instructions for selectively combining the first pixel array and the second pixel array based on the comparison, where outputting the second image frame includes outputting a combination of the second and third image.

In some examples of the method, apparatuses, and non-transitory computer-readable medium described herein, the first array of pixels and the second array of pixels may be captured in parallel, and where the sensor may be a high dynamic range (HDR) sensor capable of supporting multiple exposure lengths.

In some examples of the method, apparatuses, and non-transitory computer-readable medium described herein, the clipping status indicates that the first image frame may be overexposed, the predicted exposure length may be shorter than the initial exposure length, and the hedged exposure length may be shorter than the predicted length.

In some examples of the method, apparatuses, and non-transitory computer-readable medium described herein, the clipping status indicates that the first image frame may be underexposed, the predicted exposure length may be longer than the initial exposure length, and the hedged exposure length may be longer than the predicted length.

Some examples of the method, apparatuses, and non-transitory computer-readable medium described herein may further include operations, features, means, or instructions for detecting clipping in the first array of pixels or the second array of pixels, where the comparison of the saturation of first array of pixels to the saturation of the second array of pixels may be based on the detected clipping.

Some examples of the method, apparatuses, and non-transitory computer-readable medium described herein may further include operations, features, means, or instructions for determining that the converged exposure length may be equal to the predicted exposure length, or may be equal to the hedged exposure length based on detecting clipping in the first array of pixels or the second array of pixels.

Some examples of the method, apparatuses, and non-transitory computer-readable medium described herein may further include operations, features, means, or instructions for determining average pixel values in the first array of pixels and the second array of pixels, where the comparison of the saturation of the first array of pixels to the saturation of the second array of pixels may be based on the average pixel values.

Some examples of the method, apparatuses, and non-transitory computer-readable medium described herein may further include operations, features, means, or instructions for determining that the converged exposure length may be equal to the predicted exposure length, or may be equal to the hedged exposure length based on the determined average pixel values.

Some examples of the method, apparatuses, and non-transitory computer-readable medium described herein may further include operations, features, means, or instructions for determining the converged exposure length such that the converged exposure length has an exposure length between the predicted exposure length and the hedged exposure length and combining the first pixel array and the second pixel array is based on the determining.

Some examples of the method, apparatuses, and non-transitory computer-readable medium described herein may further include operations, features, means, or instructions for determining the converged exposure length such that the converged exposure length has an exposure length between the predicted exposure length and the hedged exposure length and where combining the first pixel array and the second pixel array is based on the determining.

Some examples of the method, apparatuses, and non-transitory computer-readable medium described herein may further include operations, features, means, or instructions for determining the converged exposure length such that the converged exposure length has an exposure length between the predicted exposure length and the hedged exposure length and combining the first pixel array and the second pixel array is based on the determining.

Some examples of the method, apparatuses, and non-transitory computer-readable medium described herein may further include operations, features, means, or instructions for determining the converged exposure length such that the converged exposure length has an exposure length between the predicted exposure length and the hedged exposure length and where combining the first pixel array and the second pixel array is based on the determining.

Some examples of the method, apparatuses, and non-transitory computer-readable medium described herein may further include operations, features, means, or instructions for applying a digital gain compensation to the first array of pixels.

In some examples of the method, apparatuses, and non-transitory computer-readable medium described herein, the converged exposure length is equal to the predicted exposure length, or is equal to the hedged exposure length.

In some examples of the method, apparatuses, and non-transitory computer-readable medium described herein, the converged exposure length is equal to the predicted exposure length, or is equal to the hedged exposure length.

In some examples of the method, apparatuses, and non-transitory computer-readable medium described herein, the converged exposure length is equal to the predicted exposure length, or is equal to the hedged exposure length.

In some examples of the method, apparatuses, and non-transitory computer-readable medium described herein, the exposure length is equal to the predicted exposure length, or is equal to the hedged exposure length.

A method of image processing at a device is described. The method may include calculating, based on a clipping status of a set of one or more pixels of a first image frame associated with a first exposure length, an exposure correction direction, a predicted exposure correction, and a hedged exposure correction that is greater than the predicted exposure correction by at least a threshold in the exposure correction direction, capturing from a sensor a first array of pixels using the predicted exposure correction and a second array of pixels using the hedged exposure correction, selecting a second exposure length based on a comparison of the first array of pixels to the second array of pixels, and outputting a second image frame based on the second exposure length.

An apparatus for image processing at a device is described. The apparatus may include a processor, memory in electronic communication with the processor, and instructions stored in the memory. The instructions may be executable by the processor to cause the apparatus to calculate, based on a clipping status of a set of one or more pixels of a first image frame associated with a first exposure length, an exposure correction direction, a predicted exposure correction, and a hedged exposure correction that is greater than the predicted exposure correction by at least a threshold in the exposure correction direction, capture from a sensor a first array of pixels using the predicted exposure correction and a second array of pixels using the hedged exposure correction, select a second exposure length based on a comparison of the first array of pixels to the second array of pixels, and output a second image frame based on the second exposure length.

Another apparatus for image processing at a device is described. The apparatus may include means for calculating, based on a clipping status of a set of one or more pixels of a first image frame associated with a first exposure length, an exposure correction direction, a predicted exposure correction, and a hedged exposure correction that is greater than the predicted exposure correction by at least a threshold in the exposure correction direction, capturing from a sensor a first array of pixels using the predicted exposure correction and a second array of pixels using the hedged exposure correction, selecting a second exposure length based on a comparison of the first array of pixels to the second array of pixels, and outputting a second image frame based on the second exposure length.

A non-transitory computer-readable medium storing code for image processing at a device is described. The code may include instructions executable by a processor to calculate, based on a clipping status of a set of one or more pixels of a first image frame associated with a first exposure length, an exposure correction direction, a predicted exposure correction, and a hedged exposure correction that is greater than the predicted exposure correction by at least a threshold in the exposure correction direction, capture from a sensor a first array of pixels using the predicted exposure correction and a second array of pixels using the hedged exposure correction, select a second exposure length based on a comparison of the first array of pixels to the second array of pixels, and output a second image frame based on the second exposure length.

In some examples of the method, apparatuses, and non-transitory computer-readable medium described herein, the clipping status of the set of one or more pixels of the first image frame indicates that the first exposure length may be underexposed, and where the exposure correction direction may be an increase in exposure.

In some examples of the method, apparatuses, and non-transitory computer-readable medium described herein, the hedged exposure correction may be overexposed, and capturing the second array of pixels includes applying a digital gain compensation to the first array of pixels.

Some examples of the method, apparatuses, and non-transitory computer-readable medium described herein may further include operations, features, means, or instructions for determining that the hedged exposure length may not be under-exposed, where selecting the second exposure length further includes setting the second exposure length equal to the hedged exposure length.

In some examples of the method, apparatuses, and non-transitory computer-readable medium described herein, the first array of pixels and the second array of pixels may be captured in parallel, and where the sensor may be a high dynamic range (HDR) sensor capable of supporting multiple exposure lengths.

### BRIEF DESCRIPTION OF THE DRAWINGS

FIG. 1 illustrates an example of an image capture system for image processing that supports auto exposure control (AEC) predictive convergence in accordance with aspects of the present disclosure.

FIG. 2 illustrates an example of an exposure convergence scheme that supports AEC predictive convergence in accordance with aspects of the present disclosure.

FIG. 3 illustrates an example of an exposure convergence scheme that supports AEC predictive convergence in accordance with aspects of the present disclosure.

FIG. 4 illustrates an example of an exposure convergence scheme that supports AEC predictive convergence in accordance with aspects of the present disclosure.

FIGS. 5 and 6 show block diagrams of devices that support AEC predictive convergence in accordance with aspects of the present disclosure.

FIG. 7 shows an apparatus that supports AEC predictive convergence in accordance with aspects of the present disclosure.

FIGS. 8-10 show flowcharts illustrating methods that support AEC predictive convergence in accordance with aspects of the present disclosure.

### DETAILED DESCRIPTION

In some cases, a captured image may have a dynamic range of lighting that exceeds an available pixel range of the capturing device. A device may utilize two or more exposures, which may be merged or combined to generate a reconstructed final image. When a scene changes, exposure in a device such as a camera may need some time to adjust. Adjusting exposure may take a large amount of time. For example, when an image is overexposed or underexposed in a first frame, resulting in pixel saturation, an algorithm may be utilized to decrease exposure in the second frame. However, when pixels clip to pure white or black, an image capturing device may not know by how much to decrease or increase the exposure to bring the image to an ideal exposure. Thus, several iterations of the algorithm may occur before converging on the ideal exposure. This may result in decreased user experience and unnecessary decrease in the quality of an image.

The improved techniques, methods, and related devices described herein may support auto exposure control (AEC) predictive convergence. AEC may utilize dynamic range compensation (DRC) capability of a device to increase the speed at which an ideal exposure can be achieved. For example, instead of automatically calculating and adopting a second, safe exposure (which may result in multiple iterations before achieving an ideal exposure) an auto exposure algorithm may set a first exposure length, and a second exposure length. The first exposure length may be calculated by the auto exposure algorithm to be different from a current exposure length, and the second exposure length may be calculated by the auto exposure algorithm to be more different from the current exposure length than the first exposure length (e.g., when a current exposure length that is overexposed, the first exposure length may be shorter than the current exposure length and the second exposure length may be shorter than the first exposure length). Based on a comparison between subsequent image frames captured using the first exposure length and the second exposure length, an ideal exposure can be determined more quickly, thereby reducing the need for DRC and its associated drawbacks. The utilization of AEC predictive convergence may increase the speed with which ideal exposure is achieved.

Aspects of the disclosure are initially described in the context of an image capture system. Aspects of the disclosure are further described in the context of exposure convergence schemes. Aspects of the disclosure are further illustrated by and described with reference to apparatus diagrams, system diagrams, and flowcharts that relate to AEC predictive convergence.

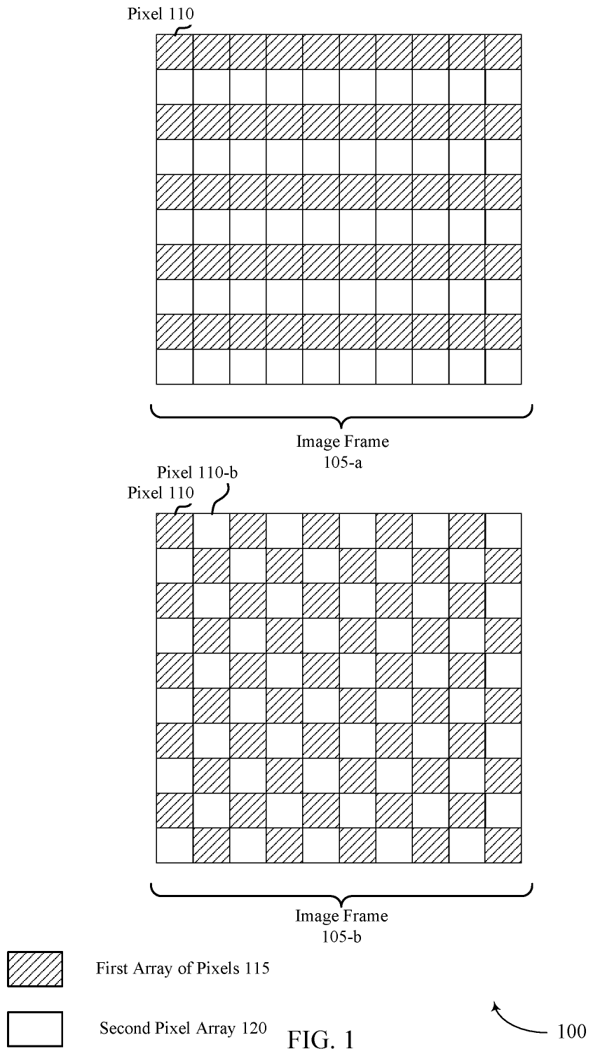

FIG. 1 illustrates an example of an image capture system 100 that supports AEC predictive convergence in accordance with aspects of the present disclosure. In some cases, a device such as a cell phone, a laptop computer, a desktop computer, or the like, may include a camera which can capture an image. The captured image (e.g., a snapshot) may be captured at a certain exposure length (e.g., a long exposure or a short exposure, etc.). That is, a device capturing an image may adjust parameters such as aperture (e.g., amount of light permitted to pass through the camera lens), shutter speed (e.g., an amount of time the shutter in front of the image capturing sensor stays open to capture an image at the sensor) and international standards organization (ISO) (e.g., sensitivity to light controlling how the sensor responds to received light). The exposure length, which may be based on one or more of these parameters, may determine the brightness or darkness of the captured image. Exposure may be determined based on one or more of a sensor gain, a film international standards organization (ISO) sensitivity setting, a lens aperture, or a fixed aperture on a device such as a smart phone.

Some device may be equipped with an auto exposure algorithm, which may adjust exposure to a reasonable or ideal level based on commonly accepted heuristics known to persons having ordinary skill in the art. For example, the algorithm may be applied to a captured image to ensure that pixels of the captured image fall within a certain range of brightness values. The auto exposure algorithms may consume statistical values (e.g., a pixel value histogram, a grid of pixel values, etc.) which may be utilized to ensure that a captured image falls within the range of brightness values.

In some examples, a device utilizing image capture system 100 may capture an image frame 105. Image frame 105 may include a total number of pixels 110. Image frame 105 may be a single image frame captured as a snapshot, or may be an image frame captured in sequence as part of a video or ongoing image (e.g., a cell phone camera in camera mode, in camera preview mode, or in video mode, or a camera of a laptop computer activated for video chat, or the like).

In some cases, image frame 105 may capture a scene with a dynamic range of light and dark. The range of brightness values for the pixels 110 may fall outside the range of brightness values. In such cases, some pixels 110 may snap to a white or black value. This snapping to extreme values may be referred to as clipping, and whether one or more pixels 110 of an image frame 105 are clipping may be referred to as a clipping status. For example, if image frame 105 captures a scene including bright sky dark shadows, then the whole sky and cloud portion of the scene may clip to white, and all shadows and objects that fall within the shadows may clip to black or be drowned in a noise floor. For example, the statistics for pixels 110 that clip to white may snap to a brightness value of 255 and the pixels 110 that clip to black may clip to a noise floor with a brightness value of 0.

In some cases, a device may capture a first image frame 105 of a scene and a second image frame 105 of the same scene, and may combine them such that the pixels 110 fall within the required range of brightness values. That is, a first image frame 105 may have a longer exposure than the second image frame 105 (e.g., a greater amount of light per unit area that reaches the sensor of an image capture device for the first image frame 105 than for the second image frame 105). Using a longer exposure may capture shadowed areas in a scene with an appropriate amount of light, but may also overexpose areas of a scene with more light. A device using a short exposure may capture bright areas in a scene with an appropriate amount of light, but may also underexpose shadowed areas. A device may be used to combine the two image frames, such that the shadows from the long exposure image frame 105 are combined with the highlights of the short exposure image frame.

In some cases, a device may capture images via a sensor, such as a high dynamic range (HDR) sensor. In some cases, a device may capture an image frame 105-a with interlaced lines, each line corresponding to a different exposure. For example, a first array of pixels 115 may correspond to a first exposure length, and second array of pixels 120 may correspond to a second exposure length. Alternatively, the device may capture an image frame 105-b with a zig-zag pattern between a first array of pixels 115 which may correspond to a first exposure length, and second array of pixels 120 which may correspond to a second exposure length. In some cases, a device may support image capture with more than 2 exposure lengths. For example, an image frame 105 may be captured with three exposure lengths corresponding to different array of pixels.

Upon capture of an image using two or more exposure lengths, a device such as a device having an HDR sensor, may construct a final image using the array of pixels corresponding to different exposure lengths. Such reconstruction may be referred to, in some examples, as DRC. For example, on a personal computer, two or more snapshots having different exposures may be combined via an image processing or image editing program. In some examples, a device may include an HDR reconstruction module to combine captured image frames 105 or image frames 105 having multiple array of pixels of different lengths. For example, a device applying HDR reconstruction may capture a first array of pixels 115 at a short exposure, and may capture a second array of pixels at a long exposure. The device may determine that a first pixel 110-a from the first array of pixels 115 is under exposed, and may instead use a second pixel 110-b from the second array of pixels 120 that was captured at a longer exposure.

However, in some cases, utilizing DRC may result in unnatural coloring. For example, in combining short exposure pixels with long exposure pixels, the skin tone of a human captured in an image frame 105 may be dull, flat, or otherwise appear unrealistic (e.g., as a single color). Additionally, the introduction of motion artifacts into a scene can complicate DRC.

In some examples, a user of a device may move from one location to another, and the lighting of the two locations may be different. Thus, the motion of the individual may affect the ideal exposure for capturing an image. In some cases, the user carrying a device may be using the camera of the device to record a vide (e.g., may be capturing a series of consecutive image frames 105). In some cases, a device may be stationary, but lighting may dynamically change (e.g., a light is turned on or off in a room where the computing device is located). When lighting changes, a device may calculate an ideal exposure, which may be different than a current exposure length, and may adjust the exposure of one or more array of pixels to capture an image frame 105. For example, the device may determine an overall exposure, and may then initiate a DRC. Additionally, or alternatively, a device may perform an overall convergence and a DRC at the same time.

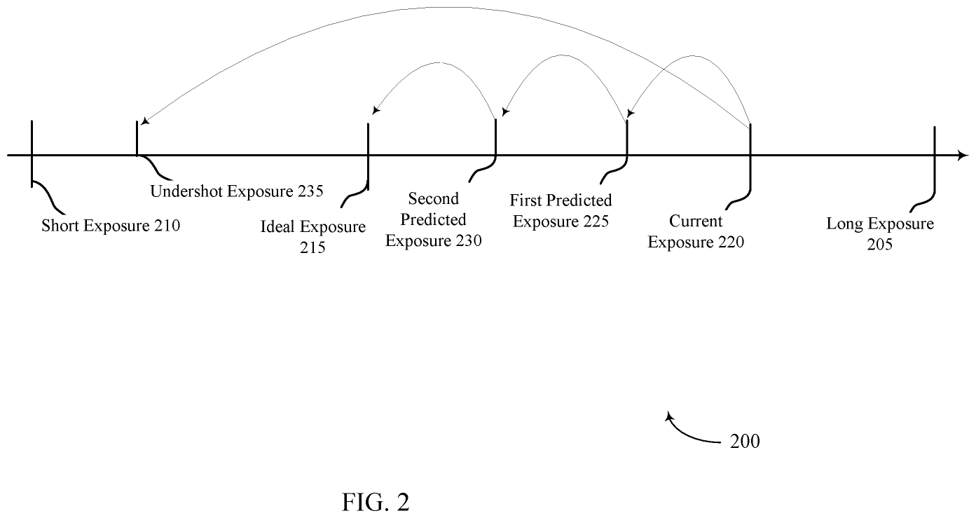

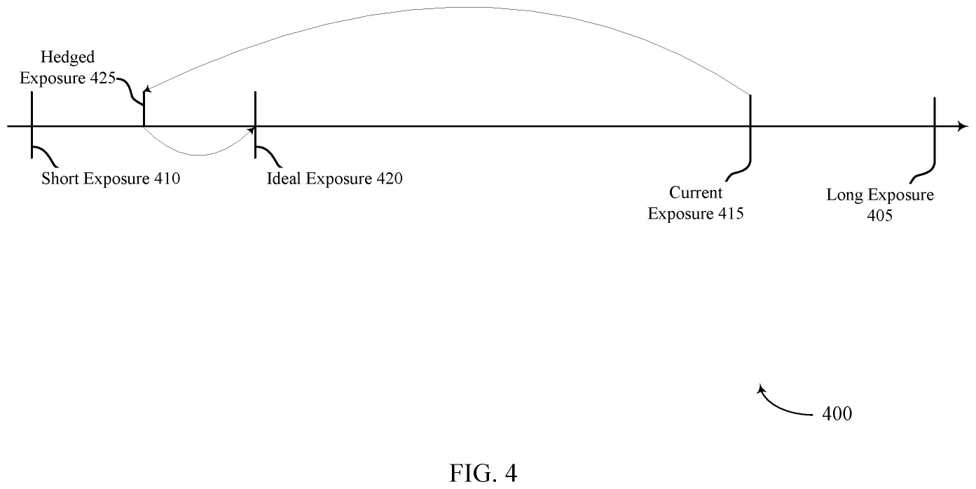

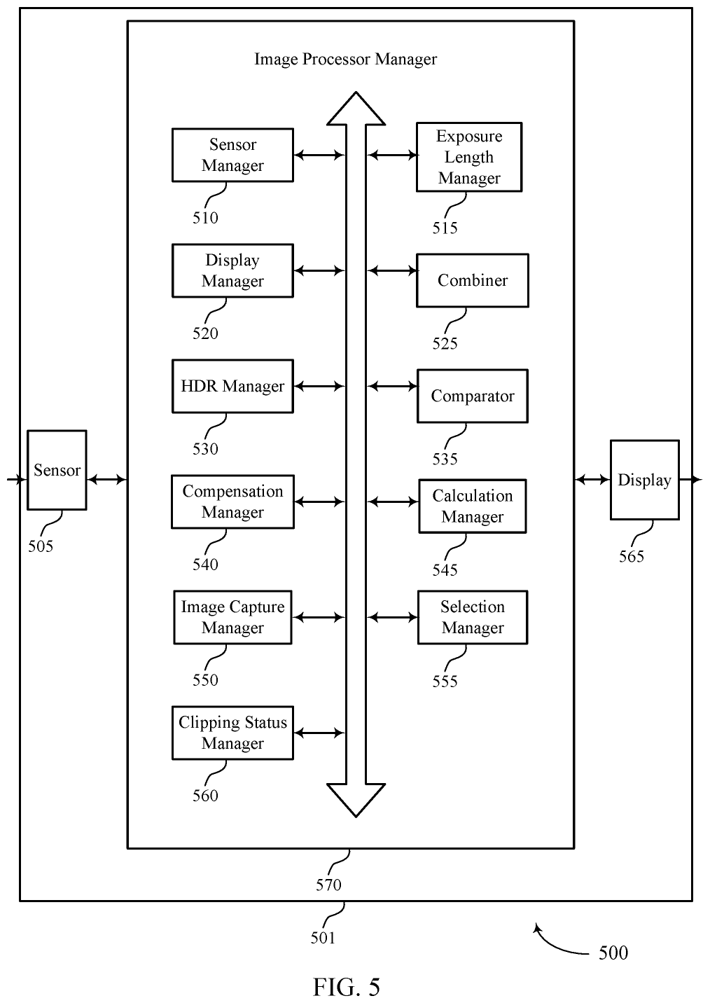

As described in more detail with respect to FIG. 2, a change in lighting or other environmental conditions may result in an exposure adjustment that takes a noticeable amount of time. However, as described in greater detail with respect to FIG. 4 and FIG. 5, a device may capture one or more arrays of pixels at different exposures, and may calculate a predicted exposure length that is relatively safe and a more extreme exposure length (e.g., a hedged exposure length that is more different from the current exposure length than the predicted exposure length), and may predictively converge on an ideal or target exposure length based at least in part on the predicted exposure length and the hedged exposure length, without expending extraneous time across multiple image frames.

FIG. 2 illustrates an example of an exposure convergence scheme 200 that supports AEC predictive convergence in accordance with aspects of the present disclosure. In some examples, exposure convergence scheme 200 may implement aspects of image capture system 100.

In some cases, an image capture device may include a sensor with a capability to capture image frames at a range of exposures including long exposure 205 and short exposure 210, and a set of possible exposure lengths between the two. In some examples, an image capture device may be turned on, and may arbitrarily select a current exposure length 220. Current exposure length 220 may be overexposed or underexposed, and image brightness values may clip to 255 or 0. Or, in some examples, a camera may move from one position to another, where the lighting conditions are different. For instance, an embedded car camera may exit a tunnel, or a person may move from inside a building to outside a building while filming with a smartphone camera. In such examples, where a current exposure length 220 is a complete miss from an ideal exposure 215, an auto exposure algorithm may scramble to achieve the ideal exposure. An adjustment from current exposure length 220 to ideal exposure 215 can be rapid to improve user experience (e.g., avoid unnecessary delays across multiple frames, or avoid whiplash between overexposed and underexposed images). Due to the clipping status of an image frame captured at a current exposure length 220, the device may easily determine that the image frame is overexposed or underexposed. However, the device may not know by how much the image frame captured at current exposure length 220 is underexposed or overexposed.

In such examples, a device may capture and image, and determine that the image is overexposed (e.g., may detect clipping in one or more pixels of the captured image), and could select an extreme or hedged exposure length for a subsequent image frame. That is, if the image is overexposed, the device may select an exposure for a subsequent image frame that has a much shorter exposure. However, if the selected exposure results in an undershot exposure 235 (an exposure that went too far from current exposure length 220, and is therefore underexposed), and then subsequent calculations result in ideal exposure 215, a user may experience a brightness whiplash as image frames are displayed. That is, consecutive image frames may be overexposed (one or more pixels of a captured image frame may be too bright and/or may clip to a maximum value), followed by underexposed (one or more pixels of the captured image frame may be too dark and/or may clip to zero), before settling on the ideal exposure 215.

In some cases where a current exposure length 220 is a complete miss, a device may apply an auto exposure algorithm to calculate a first predicted exposure length 225, and capture an image at that exposure length. However, the device may not know the extend to which current exposure length 220 is overexposed. The device may only know that some pixels are clipping. In such cases, first predicted exposure length 225 may still be overexposed, and at least some pixels of one or more array of pixels in the captured image frame may still be clipping. The device may calculate a second predicted exposure length 230 and may capture an image using that exposure length, but second predicted exposure length 230 may also be overexposed. It may take multiple iterations of calculations before achieving the ideal exposure 215, which may in turn result in decreased user experience and unnecessary delays before correctly capturing an image frame at the appropriate exposure.

Instead, as described in greater detail with respect to FIG. 4 and FIG. 5, a device may capture more than one array of pixels at more than one exposure length to quickly and predictively converge on ideal exposure 215.

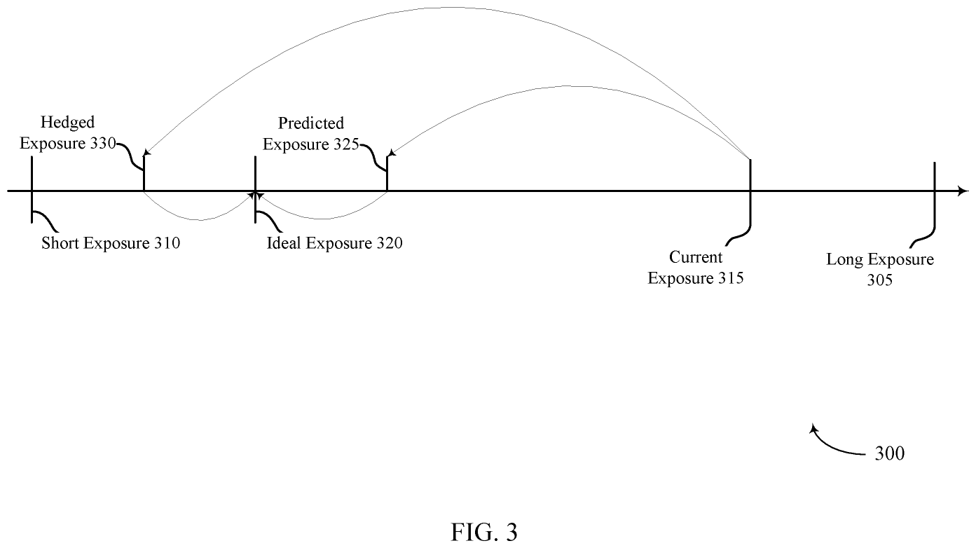

FIG. 3 illustrates an example of an exposure convergence scheme 300 that supports AEC predictive convergence in accordance with aspects of the present disclosure. In some examples, exposure convergence scheme 300 may implement aspects of image capture system 100.

In some cases, as described with respect to FIG. 2, a device with a camera may encounter situations in which an ideal exposure is unknown (e.g., when lighting conditions undergo a rapid and/or extreme change). In such cases, the device may utilize a DRC capability to more rapidly converge on an ideal exposure. The device may utilize the DRC capabilities for rapid convergence even in cases where a DRC is not required for a particular scene.

In some examples, an image capture device may include a sensor capable of capturing image frames at a range of exposures including long exposure 305 and short exposure 310, and a set of exposure lengths between the two. In some examples, the device may utilize a sensor to capture a first image frame with a current exposure length 315, and the captured image frame may be overexposed or underexposed. Image brightness values of the first image frame may clip to 255 or 0. For example, as shown in FIG. 3, an image captured using current exposure length 315 of a first image frame may be overexpose, and pixels may clip to a brightness value of 255. However, the device may not know the extent to which the image captured using exposure length 315 is overexposed.

The device may apply an auto exposure algorithm to calculate a predicted exposure length 325. However, based on the clipping status of the pixels of the first image frame, the device may also apply the auto exposure algorithm to hedged exposure length 330. Hedged exposure length 330 may have an exposure length that is different from predicted exposure length 325 by at least a threshold value. Thus, if the predicted exposure length 325 is shorter than the current exposure length 315, then hedged exposure length 330 may be shorter still by a threshold. Alternatively, if predicted exposure length 325 is longer than current exposure length 315, then hedged exposure length 330 may be longer still by at least the threshold.

In some examples, the device may capture, at the sensor, an image frame having a plurality of arrays of pixels. For example, the device may capture a first array of pixels and a second array of pixels. In some examples, the first array of pixels and the second array of pixels may be first array of pixels 115 and second array of pixels 120, as shown and described with reference to FIG. 1. In some examples, the sensor of a device may capture a first array of pixels using the predicted exposure length 325 and a second array of pixels using the hedged exposure length 330. The device may compare the saturation of a first array of pixels captured using predicted exposure length 325 and a saturation of a second array of pixels captured using hedged exposure length 330. The device may use the compared saturation levels to identify the ideal exposure 320. For example, the device may select one of the array of pixels captured using hedged exposure length 330 or the array of pixels captured using predicted exposure length 325, and may determine that the selected array of pixels may be utilized to generate an image with an appropriate exposure (e.g., an exposure that falls within the available range of brightness values for the device, and/or the array of pixels that does not have any pixels clipping). In some cases, the device may determine to combine the array of pixels captured using hedged exposure length 330 and the array of pixels captured using predicted exposure length 325. For example, if a first array of pixels has some pixels that are clipping to 0, then pixels from the second array of pixels may be used to replace these pixels. Similarly, if pixels form the second array of pixels are clipping to 255, then the device may replace those pixels with pixels from the first array of pixels.

In some examples, the device may apply an image reconstruction algorithm to the first array of pixels and the second array of pixels to identify the ideal exposure 320. For example, the device may determine that the hedged exposure length 330 is equivalent to or close to equivalent to the ideal exposure 320. For example, the device may compare a saturation level of the first array of pixels and the second array of pixels, and may determine that the saturation level of the second array of pixels falls within the acceptable range for the device. In some examples, the device may determine an average brightness value for each pixel array, and may determine that the average brightness value of the second pixel array is within an acceptable range for the device. In some examples, the device may determine that there is no clipping in the second array of pixels. In each of these examples, the device may output a second image frame based on the captured second array of pixels captured using the hedged exposure length 330. In some examples, the device may determine that the predicted exposure length 325 is equivalent to or nearly equivalent to the ideal exposure 320, based on a comparison of the saturation level of the first and second arrays of pixels, an average brightness value for the first and second arrays of pixels, an average brightness value for the first and/or second array of pixels, or the like, as described above. In such examples, if the device determines that the predicted exposure length 325 is equivalent to or nearly equivalent to the ideal exposure 320, then the device may output a second image frame based on the captured first array of pixels captured using the predicted exposure length 325.

Similarly, in some cases, the device may detect clipping in the first array of pixels at predicted exposure length 325, and may therefore output the second image frame based on the second array of pixels at hedged exposure length 330, or may detect clipping in the second array of pixels at hedged exposure length 330, and may therefore output the second image frame based on the first array of pixels at predicted exposure length 325. In some examples, the device may take an average pixel value of the first array of pixels and an average pixel value of the second array of pixels. In such examples, the device may compare the two averages, and may determine whether ideal exposure 320 is equal to or close to equal to one of predicted exposure length 325 or hedged exposure length 330 based on the compared averages. Similarly, the device may determine to selectively combine the first array of pixels and the second array of pixels based thereon based on the compared average values.

In some cases, the device may selectively combine the first array of pixels and the second array of pixels and output the second image frame based on the first array of pixels and the second array of pixels. For example, the device may calculate that the ideal exposure 320 is shorter than predicted exposure length 325 but longer than hedged exposure length 330. In such cases, the device may utilize the DRC capabilities to output a second image frame based on a combination of the first array of pixels and the second array of pixels.

In an illustrative example, a device may determine a clipping status of a set of one or more pixels of a first image frame captured using a current exposure length 315. For example, one or more pixels of an image frame captured using current exposure length 315 may be overexposed and may clip to 255. The device may also determine an exposure correction direction. For example, the device may determine that the exposure correction direction from current exposure length direction from current exposure length 315 is to a shorter exposure, in the direction of short exposure 310. Based on the clipping status and/or the exposure correction direction, the device may calculate predicted exposure length 325 and hedged exposure length 330. In some cases, the device may determine a minimum threshold difference between predicted exposure length 325 and hedged exposure length 330. In such examples, the device may calculate predicted exposure length 325 based on an algorithm, and may set hedged exposure length 330 based on the threshold difference (e.g., at the threshold difference or at some value greater than the threshold value). In some examples, the difference between the current exposure length 315 and the h edged exposure 330 may be set less than a maximum difference value. The minimum and maximum difference values could be preconfigured at the device. The minimum and maximum difference values could be based on an available pixel range of the capturing device. The same method can be applied if the current exposure length 315 is underexposed, and the exposure correction direction is towards a longer exposure in the direction of long exposure 305.

In some cases, the sensor of the device may be an HDR sensor, with DRC capabilities. In such examples, the first array of pixels and the second array of pixels may be captured in parallel (e.g., at the same time or nearly the same time). For example, the first array of pixels and the second array of pixels may be organized in a zig zag pattern, as described with respect to FIG. 1. In some examples, the device may have capabilities to capture more than two arrays of pixels, and/or more than two exposure lengths. In such cases, the device may capture, for example, three arrays of pixels at three different exposure lengths, and may output a second image frame based on a comparison of all three arrays of pixels.

In some cases, the device may not have an HDR sensor capable of capturing multiple arrays of pixels in parallel. In such examples, the device may instead utilize a digital gain compensation to obtain the second array of pixels and/or to converge on the ideal exposure 320.

FIG. 4 illustrates an example of an exposure convergence scheme 400 that supports AEC predictive convergence in accordance with aspects of the present disclosure. In some examples, an exposure convergence scheme 400 may implement aspects of image capture system 100.

In some examples, an image capture device may include a sensor with a capability to capture image frames at a range of exposures including long exposure 405 and short exposure 410, and a set of exposures between the two. In some examples, the device may utilize a sensor to capture a first image frame with a current exposure length 415, and the captured image frame may be overexposed or underexposed. Image brightness values of the first image frame may clip to 255 or 0. For example, current exposure length 415 of a first image frame may be overexpose, and pixels may clip to a brightness value of 255. The device may not know, based on the clipping status of the pixels of the first image, by how much the current exposure length 415 is overexposed.

In some cases, a device may not capture a first array of pixels and a second array of pixels simultaneously. For example, a device may not be equipped with an HDR sensor capable of parallel image capture. In such cases, a device may calculate a hedged exposure length 425. Hedged exposure length 425 may be different from the current exposure length 415 by at least a threshold. The device may capture an image frame using hedged exposure length 425. The device may apply a digital gain compensation to the first array of pixels. In some cases, the device may automatically apply a predetermined digital gain to a first array of pixels included in the captured image frame, which may result in a second array of pixels having an exposure that is different from the hedged exposure length 425 by some threshold. In some cases, the device may compare the saturation of the first array of pixels and the second array of pixels, and may capture or generate a second image frame based on the comparison.

In some cases, the device may apply the digital gain selectively to all pixels of the captured image frame, or may apply the digital gain selectively to a subset of pixels of the captured image frame. For instance, the device may apply the digital gain to a subset of pixels of the captured image frame that experience clipping. In such examples, applying the digital gain compensation to the array of pixels captured using the hedged exposure length 425 may result in a pixel array at ideal exposure 420. The device may then output a second image frame using the ideal exposure 420. In some examples, the device may determine that hedged exposure length 425 is equal to or nearly equal to ideal exposure 420, and may output a second image frame based on hedged exposure length 425, without applying a digital gain compensation.

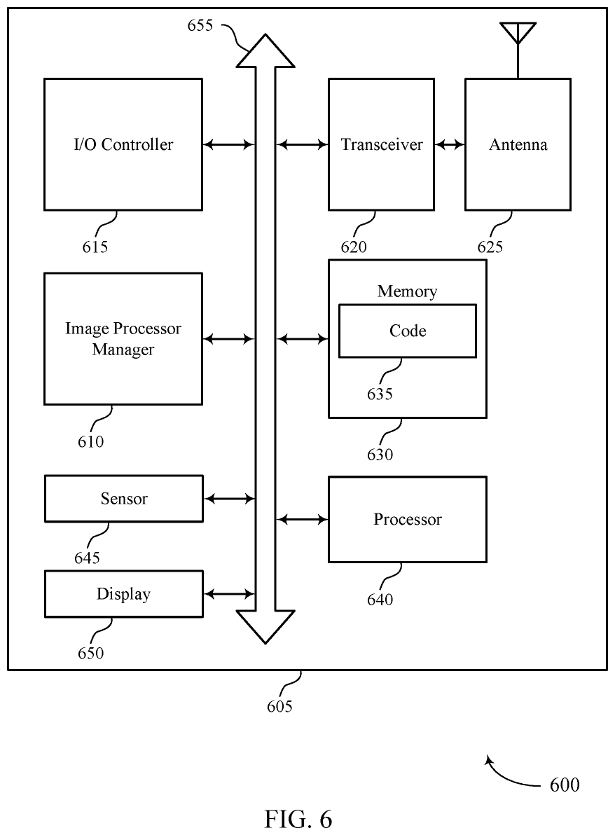

In the examples described above, a device may be able to predictively converge on ideal exposure 420 quickly (e.g., the device may change from a current exposure length 415 in a first image frame to an ideal exposure 420 in a consecutive subsequent image frame without any intervening overexposed or undershot image frames). Devices, such as those described with respect to FIG. 5 and FIG. 6, may be equipped with various modules and/or managers to execute the methods described herein.

FIG. 5 shows a block diagram 500 of a device 501 that supports AEC predictive convergence in accordance with aspects of the present disclosure. The device 501 may be an example of aspects of a device as described herein. The device 501 may include a sensor 505, an image processor manager 570, and a display 565. The device 501 may also include a processor. Each of these components may be in communication with one another (e.g., via one or more buses).

The sensor 505 may capture a first image frame using an initial exposure. Sensor 505 may also be controlled by sensor manager 510, an exposure length manager 515, an HDR manager 530, and/or an image capture manager 550, as described below. The sensor 505 may be utilized to capture an image frame such as image frame 105 and an array of pixels such as first array of pixels 115 or second array of pixels 120 as described with reference to FIG. 1.

Image processor manager 570 may be an example of a device with an image capturing ability as described with respect to FIGS. 1-4. The image processor manager 570 may include a sensor manager 510, an exposure length manager 515, a display manager 520, a combiner 525, an HDR manager 530, a comparator 535, a compensation manager 540, a calculation manager 545, an image capture manager 550, a selection manager 555, and a clipping status manager 560. Each of these modules may communicate, directly or indirectly, with one another (e.g., via one or more buses).

Image processor manager 570 or its sub-components, may be implemented in hardware, code (e.g., software or firmware) executed by a processor, or any combination thereof. If implemented in code executed by a processor, the functions of the image processor manager 570, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The image processor manager 570, or its sub-components, may be physically located at various positions, including being distributed such that portions of functions are implemented at different physical locations by one or more physical components. In some examples, the image processor manager 570, or its sub-components, may be a separate and distinct component in accordance with various aspects of the present disclosure. In some examples, the image processor manager 570, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The sensor manager 510 may capture from a sensor a first image frame using an initial exposure length. In some cases, sensor manager 510 may determine that the clipping status indicates that the first image frame is overexposed, the predicted exposure length is shorter than the initial exposure length, and the hedged exposure length is shorter than the predicted length. In some cases, sensor manager 510 may determine that the clipping status indicates that the first image frame is underexposed, the predicted exposure length is longer than the initial exposure length, and the hedged exposure length is longer than the predicted length.

The exposure length manager 515 may calculate, based on a clipping status of a set of one or more pixels of the first image frame, a predicted exposure length and a hedged exposure length, where the predicted exposure length is different from the hedged exposure length by at least a threshold. In some examples, the exposure length manager 515 may capture from the sensor a first array of pixels using the predicted exposure length and a second array of pixels using the hedged exposure length. In some examples, the exposure length manager 515 may capture from the sensor a second image frame using a converged exposure length, where the converged exposure length is based on a comparison of a saturation of the first array of pixels to a saturation of the second array of pixels. In some examples, the exposure length manager 515 may determine the converged exposure length such that the converged exposure length has an exposure length between the predicted exposure length and the hedged exposure length.

In some examples, the exposure length manager 515 may determine that the converged exposure length is equal to the predicted exposure length, or is equal to the hedged exposure length based on detecting clipping in the first array of pixels or the second array of pixels. In some examples, the exposure length manager 515 may determine that the converged exposure length is equal to the predicted exposure length or is equal to the hedged exposure length based on the determined average pixel values. In some examples, exposure length manager 515 may determine that the hedged exposure length is not under-exposed, where selecting the second exposure length further includes setting the second exposure length equal to the hedged exposure length. In some cases, exposure length manager 515 may determine that the converged exposure length is equal to the predicted exposure length or is equal to the hedged exposure length.

The display manager 520 may output the second image frame. In some examples, the display manager 520 may output a second image frame based on the second exposure length.

The combiner 525 may combine the first array of pixels and the second array of pixels based on the determining. In some examples, combiner 525 may selectively combine the first array of pixels and the second array of pixels based on the comparison, and may output the second image frame including outputting a combination of the first array of pixels and the second array of pixels.

The calculation manager 545 may calculate, based on a clipping status of a set of one or more pixels of a first image frame associated with a first exposure length, an exposure correction direction, a predicted exposure length correction, and a hedged exposure length correction that is greater than the predicted exposure length correction by at least a threshold in the exposure correction direction.

The image capture manager 550 may capture from a sensor a first array of pixels using the predicted exposure length correction and a second array of pixels using the hedged exposure length correction.

The selection manager 555 may select a second exposure length based on a comparison of the first array of pixels to the second array of pixels.

The HDR manager 530 may capture the first array of pixels and the second array of pixels in parallel, and may determine that the sensor is an HDR sensor capable of supporting multiple exposure lengths. In some cases, HDR manager 530 may capture the first array of pixels and the second array of pixels in parallel, and the sensor may be an HDR sensor capable of supporting multiple exposure lengths.

The comparator 535 may detect clipping in the first array of pixels or the second array of pixels, where the comparison of the saturation of first array of pixels to the saturation of the second array of pixels is based on the detected clipping. In some examples, the comparator 535 may determine average pixel values in the first array of pixels and the second array of pixels, where the comparison of the saturation of the first array of pixels to the saturation of the second array of pixels is based on the average pixel values.

The compensation manager 540 may apply a digital gain compensation to the first array of pixels. In some cases, the hedged exposure length correction is overexposed, and where capturing the second array of pixels includes applying a digital gain compensation to the first array of pixels.

The clipping status manager 560 may determine that the clipping status of the set of one or more pixels of the first image frame indicates that the first exposure length is underexposed, and the exposure correction direction may be an increase in exposure.

The display 565 may output the second image frame. In some cases, the second image frame may be based on a second exposure length. In some examples, display 565 may be controlled by display manager 520.

FIG. 6 shows a diagram of a system 600 including a device 605 that supports AEC predictive convergence in accordance with aspects of the present disclosure. The device 605 may be an example of or include the components of device 501, or a device as described herein. The device 605 may include components for bi-directional voice and data communications including components for transmitting and receiving communications, including an image processor manager 610, an I/O controller 615, a transceiver 620, an antenna 625, memory 630, and a processor 640. These components may be in electronic communication via one or more buses (e.g., bus 655).

The sensor 645 may capture a first image frame using an initial exposure. The sensor 645 may be utilized to capture an image frame such as image frame 105 and an array of pixels such as first array of pixels 115 or second array of pixels 120 as described with reference to FIG. 1. Sensor 645 may also capture subsequent images using a hedged exposure and/or a predicted exposure.

The image processor manager 610 may manage or trigger capture from sensor 645 of a first image frame using an initial exposure length, calculate, based on a clipping status of a set of one or more pixels of the first image frame, a predicted exposure length and a hedged exposure length, where the predicted exposure length is different from the hedged exposure length by at least a threshold, and may manage or trigger capture from the sensor 645, a first array of pixels using the predicted exposure length and a second array of pixels using the hedged exposure length. Image processor manager 610 may manager or trigger capture from the sensor 645 a second image frame using a converged exposure length, where the converged exposure length is based on a comparison of a saturation of the first array of pixels to a saturation of the second array of pixels, and output the second image frame. The image processor manager 610 may also determine the converged exposure length such that the converged exposure length has an exposure length between the predicted exposure length and the hedged exposure length and where combining the first array of pixels and the second array of pixels is based on the determining.

The image processor manager 610 may also calculate, based on a clipping status of a set of one or more pixels of a first image frame associated with a first exposure length, an exposure correction direction, a predicted exposure length correction, and a hedged exposure length correction that is greater than the predicted exposure length correction by at least a threshold in the exposure correction direction. The image processor manager 610 may capture from a sensor 645 a first array of pixels using the predicted exposure length correction and a second array of pixels using the hedged exposure length correction, select a second exposure length based on a comparison of the first array of pixels to the second array of pixels, and output a second image frame to a display 650 based on the second exposure length. In some cases, the converged exposure length is equal to the predicted exposure length, or is equal to the hedged exposure length.

The display 650 may output one or more captured image frames, such as the second image frame. In some cases, the second image frame may be based on a second exposure length.

The I/O controller 615 may manage input and output signals for the device 605. The I/O controller 615 may also manage peripherals not integrated into the device 605. In some cases, the I/O controller 615 may represent a physical connection or port to an external peripheral. In some cases, the I/O controller 615 may utilize an operating system such as iOS®, ANDROID®, MS-DOS®, MS-WINDOWS®, OS/2®, UNIX®, LINUX®, or another known operating system. In other cases, the I/O controller 615 may represent or interact with a modem, a keyboard, a mouse, a touchscreen, or a similar device. In some cases, the I/O controller 615 may be implemented as part of a processor. In some cases, a user may interact with the device 605 via the I/O controller 615 or via hardware components controlled by the I/O controller 615.

The transceiver 620 may communicate bi-directionally, via one or more antennas, wired, or wireless links as described above. For example, the transceiver 620 may represent a wireless transceiver and may communicate bi-directionally with another wireless transceiver. The transceiver 620 may also include a modem to modulate the packets and provide the modulated packets to the antennas for transmission, and to demodulate packets received from the antennas.

In some cases, the wireless device may include a single antenna 625. However, in some cases the device may have more than one antenna 625, which may be capable of concurrently transmitting or receiving multiple wireless transmissions.

The memory 630 may include RAM and ROM. The memory 630 may store computer-readable, computer-executable code 635 including instructions that, when executed, cause the processor to perform various functions described herein. In some cases, the memory 630 may contain, among other things, a BIOS which may control basic hardware or software operation such as the interaction with peripheral components or devices.

The processor 640 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 640 may be configured to operate a memory array using a memory controller. In other cases, a memory controller may be integrated into the processor 640. The processor 640 may be configured to execute computer-readable instructions stored in a memory (e.g., the memory 630) to cause the device 605 to perform various functions (e.g., functions or tasks supporting AEC predictive convergence).

The code 635 may include instructions to implement aspects of the present disclosure, including instructions to support image processing. The code 635 may be stored in a non-transitory computer-readable medium such as system memory or other type of memory. In some cases, the code 635 may not be directly executable by the processor 640 but may cause a computer (e.g., when compiled and executed) to perform functions described herein.

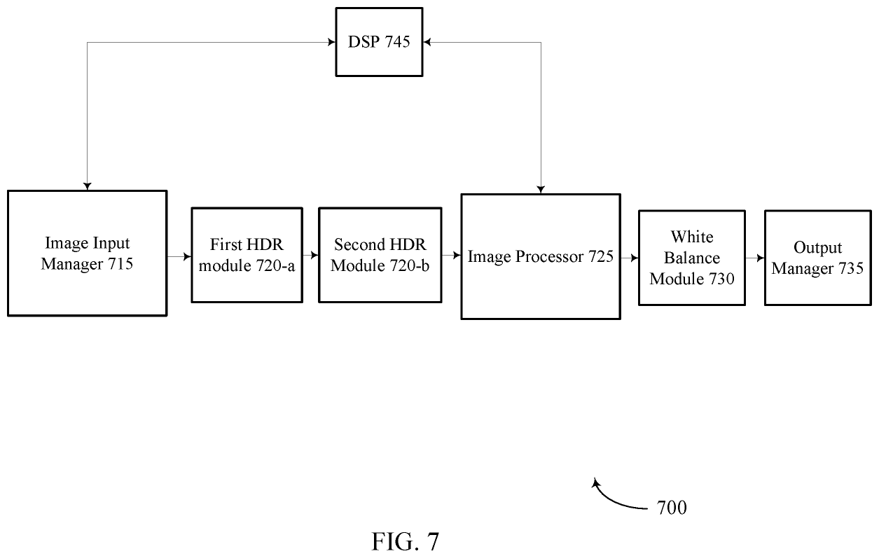

FIG. 7 shows an apparatus 800 that supports AEC predictive convergence in accordance with aspects of the present disclosure. The operations of apparatus 800 may be implemented by components as described herein.

The apparatus may include, for example, an image input manager. Image input manager 715 may be a single module or may include multiple modules. For example, the image input manager 715 may include at least one single instruction, multiple data (SIMD) processor. In some examples, such processors may be in communication with one or more digital signal processor (DSP) 745. In some examples, image input manager 715 may also include other components, such as a linearization component, a picture dependent prediction combination (PDPC) component, and/or a channel gain manager.

The apparatus may also include one or more HDR module 720. For example, the apparatus may include first HDR module 720-a and second HDR module 720-b. In some examples, a single HDR module may perform the functions of first HDR module 720-a and second HDR module 720-b. First HDR module 720-a may, for example, manage HDR reconstruction. That is, HDR module 720-a may receive, from one or more submodules of image input manager 715, a captured first array of pixels and a captured second array of pixels. First HDR module 720-a may reconstruct an image based on the received first and second array of pixels, as described in greater detail with respect to, for example, FIG. 3. In some examples, second HDR module 720-b may cooperate with first HDR module 720-a in reconstructing one or more images based on received arrays of pixels. Additionally, or alternatively, first HDR module 720-a may reconstruct separate arrays of pixels, and second HDR module 720-b may selectively combine the arrays of pixels reconstructed by first HDR module 720-a. In some examples, an apparatus may not include or may not utilize one or both of first HDR module 720-a and/or second HDR module 720-b. In such cases, the apparatus may support AEC predictive convergence without HDR capabilities, as described in greater detail below. The apparatus may also include image processor 725. Image processor 725 may be a single module, or may include multiple modules. For example, the image processor 725 may include at least one single instruction, multiple data (SIMD) processor. In some examples, such processors may be in communication with one or more DSP 745. In some examples, image processor 725 may also include other components, such as black point compensation (BPC) module and/or a baseline correction circuit (BCC) module, an adaptive bilateral filter (ABF), a backlight selection (BLS) module, a cropping module, and/or a lens shading correction (LSC) module. Image processor 725 may receive images, which may have been HDR reconstructed at HDR module 720, and may further process and/or prepare the images for display.

However, in some cases, as discussed above, a device may not have HDR capabilities. For example, the device may not include HDR modules 720. In such cases, statistics may tap out (e.g., one or more pixels of an image captured at input manager 715 may clip). Tapping out may occur at one of the processors of image processor 725, or may occur at the end of image processor 725. In some examples, white balance module 730 may detect clipping of one or more pixels, and may apply a digital gain to the pixels. For instance, a sensor of the device may capture an array of pixels at an exposure length that is underexposed. White balance module 730 may detect the underexposed pixels of the array of pixels, and may apply a digital gain. In some examples, output manager 735 (which may include one or more additional modules) may determine an ideal exposure for outputting an image frame by comparing a saturation level of the captured array of pixels, and a saturation level of the array of pixels after application of the digital gain by white balance module 730. That is, the device may determine that the captured array of pixels is clipping but that the array of pixels having a digital gain applied is not clipping, and may output an image frame using the selectively applied digital gain. In some examples, the device may determine that there is no clipping occurring, and may determine not to apply a digital gain at white balance module 730. In some examples, output manager 735 may output an image frame based on the captured array of pixels having an applied digital gain by calculating an average saturation level of the array of pixels having an applied digital gain. For example, the average saturation level may fall within an acceptable range of brightness values. The apparatus 700 may utilize an existing white balance module 730 that is utilized for balancing whiteness of pixels to apply the methods described above. Alternatively, a white balance module 730 may be configured in an apparatus 700 with the purpose of applying digital gain to a captured array of pixels, as described above. The components of apparatus 700 may act independently from each other, or may execute one or more of the steps described above interchangeably.

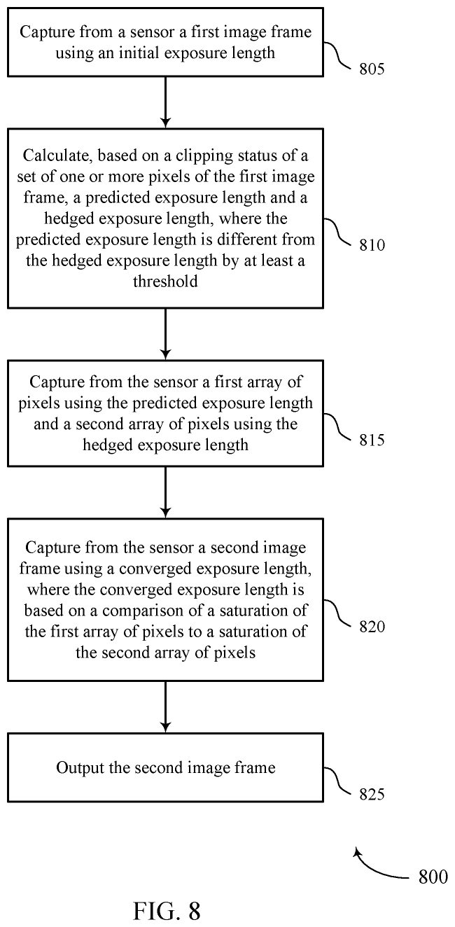

FIG. 8 shows a flowchart illustrating a method 800 that supports AEC predictive convergence in accordance with aspects of the present disclosure. The operations of method 800 may be implemented by a device or its components as described herein. For example, the operations of method 800 may be performed by an image processor manager as described with reference to FIGS. 5 through 6. In some examples, a device may execute a set of instructions to control the functional elements of the device to perform the functions described below. Additionally, or alternatively, a device may perform aspects of the functions described below using special-purpose hardware.

At 805, the device may capture from a sensor a first image frame using an initial exposure length. The operations of 805 may be performed according to the methods described herein. In some examples, aspects of the operations of 805 may be performed by a sensor manager as described with reference to FIGS. 5 through 6.

At 810, the device may calculate, based on a clipping status of a set of one or more pixels of the first image frame, a predicted exposure length and a hedged exposure length, where the predicted exposure length is different from the hedged exposure length by at least a threshold. The operations of 810 may be performed according to the methods described herein. In some examples, aspects of the operations of 810 may be performed by an exposure length manager as described with reference to FIGS. 5 through 6.

At 815, the device may capture from the sensor a first array of pixels using the predicted exposure length and a second array of pixels using the hedged exposure length. The operations of 815 may be performed according to the methods described herein. In some examples, aspects of the operations of 815 may be performed by an exposure length manager as described with reference to FIGS. 5 through 6.

At 820, the device may capture from the sensor a second image frame using a converged exposure length, where the converged exposure length is based on a comparison of a saturation of the first array of pixels to a saturation of the second array of pixels. The operations of 820 may be performed according to the methods described herein. In some examples, aspects of the operations of 820 may be performed by an exposure length manager as described with reference to FIGS. 5 through 6.

At 825, the device may output the second image frame. The operations of 825 may be performed according to the methods described herein. In some examples, aspects of the operations of 825 may be performed by a display manager as described with reference to FIGS. 5 through 6.

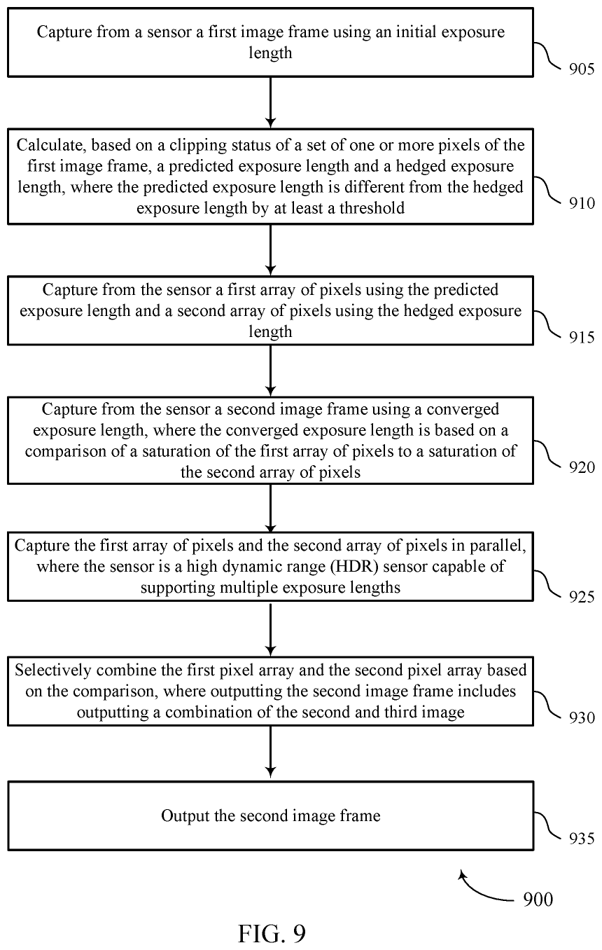

FIG. 9 shows a flowchart illustrating a method 900 that supports AEC predictive convergence in accordance with aspects of the present disclosure. The operations of method 900 may be implemented by a device or its components as described herein. For example, the operations of method 900 may be performed by an image processor manager as described with reference to FIGS. 5 through 6. In some examples, a device may execute a set of instructions to control the functional elements of the device to perform the functions described below. Additionally, or alternatively, a device may perform aspects of the functions described below using special-purpose hardware.

At 905, the device may capture from a sensor a first image frame using an initial exposure length. The operations of 905 may be performed according to the methods described herein. In some examples, aspects of the operations of 905 may be performed by a sensor manager as described with reference to FIGS. 5 through 6.

At 910, the device may calculate, based on a clipping status of a set of one or more pixels of the first image frame, a predicted exposure length and a hedged exposure length, where the predicted exposure length is different from the hedged exposure length by at least a threshold. The operations of 910 may be performed according to the methods described herein. In some examples, aspects of the operations of 910 may be performed by an exposure length manager as described with reference to FIGS. 5 through 6.

At 915, the device may capture from the sensor a first array of pixels using the predicted exposure length and a second array of pixels using the hedged exposure length. The operations of 915 may be performed according to the methods described herein. In some examples, aspects of the operations of 915 may be performed by an exposure length manager as described with reference to FIGS. 5 through 6.

At 920, the device may capture from the sensor a second image frame using a converged exposure length, where the converged exposure length is based on a comparison of a saturation of the first array of pixels to a saturation of the second array of pixels. The operations of 920 may be performed according to the methods described herein. In some examples, aspects of the operations of 920 may be performed by an exposure length manager as described with reference to FIGS. 5 through 6.

At 925, the device may capture the first array of pixels and the second array of pixels in parallel, and the sensor is an HDR sensor capable of supporting multiple exposure lengths. The operations of 925 may be performed according to the methods described herein. In some examples, aspects of the operations of 925 may be performed by a display manager as described with reference to FIGS. 5 through 6.

At 930, the device may selectively combine the first array of pixels and the second array of pixels based on the comparison, where outputting the second image frame includes outputting a combination of the first array of pixels and the second array of pixels. The operations of 930 may be performed according to the methods described herein. In some examples, aspects of the operations of 930 may be performed by a combiner as described with reference to FIGS. 5 through 6.

At 935, the device may output the second image frame. The operations of 935 may be performed according to the methods described herein. In some examples, aspects of the operations of 935 may be performed by an HDR manager as described with reference to FIGS. 5 through 6.

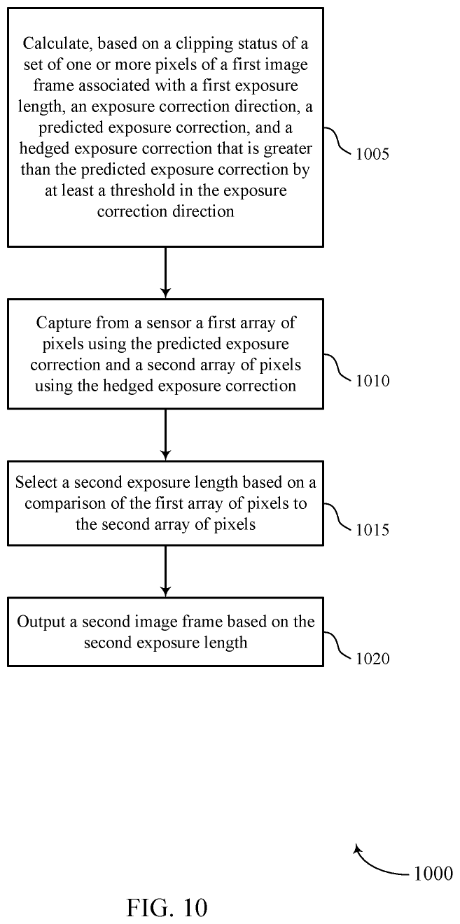

FIG. 10 shows a flowchart illustrating a method 1000 that supports AEC predictive convergence in accordance with aspects of the present disclosure. The operations of method 1000 may be implemented by a device or its components as described herein. For example, the operations of method 1000 may be performed by an image processor manager as described with reference to FIGS. 5 through 6. In some examples, a device may execute a set of instructions to control the functional elements of the device to perform the functions described below. Additionally, or alternatively, a device may perform aspects of the functions described below using special-purpose hardware.

At 1005, the device may calculate, based on a clipping status of a set of one or more pixels of a first image frame associated with a first exposure length, an exposure correction direction, a predicted exposure length correction, and a hedged exposure length correction that is greater than the predicted exposure length correction by at least a threshold in the exposure correction direction. The operations of 1005 may be performed according to the methods described herein. In some examples, aspects of the operations of 1005 may be performed by a calculation manager as described with reference to FIGS. 5 through 6.

At 1010, the device may capture from a sensor a first array of pixels using the predicted exposure length correction and a second array of pixels using the hedged exposure length correction. The operations of 1010 may be performed according to the methods described herein. In some examples, aspects of the operations of 1010 may be performed by an image capture manager as described with reference to FIGS. 5 through 6.

At 1015, the device may select a second exposure length based on a comparison of the first array of pixels to the second array of pixels. The operations of 1015 may be performed according to the methods described herein. In some examples, aspects of the operations of 1015 may be performed by a selection manager as described with reference to FIGS. 5 through 6.

At 1020, the device may output a second image frame based on the second exposure length. The operations of 1020 may be performed according to the methods described herein. In some examples, aspects of the operations of 1020 may be performed by a display manager as described with reference to FIGS. 5 through 6.

It should be noted that the methods described above describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field-programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for image processing at a device, comprising:
capturing from a sensor a first image frame using an initial exposure length;
calculating, based at least in part on a clipping status of a set of one or more pixels of the first image frame, a predicted exposure length and a hedged exposure length, wherein the predicted exposure length is different from the hedged exposure length by at least a threshold;
capturing from the sensor a first array of pixels using the predicted exposure length and a second array of pixels using the hedged exposure length;
capturing from the sensor a second image frame using a converged exposure length, wherein the converged exposure length is based at least in part on a comparison of a saturation of the first array of pixels to a saturation of the second array of pixels; and
outputting the second image frame.

2. The method of claim 1, further comprising:
selectively combining the first array of pixels and the second array of pixels based at least in part on the comparison, wherein outputting the second image frame comprises outputting a combination of the first array of pixels and the second array of pixels.

3. The method of claim 1, wherein the first array of pixels and the second array of pixels are captured in parallel, and wherein the sensor is a high dynamic range (HDR) sensor capable of supporting multiple exposure lengths.

4. The method of claim 1, wherein the clipping status indicates that the first image frame is overexposed, the predicted exposure length is shorter than the initial exposure length, and the hedged exposure length is shorter than the predicted length.

5. The method of claim 1, wherein the clipping status indicates that the first image frame is underexposed, the predicted exposure length is longer than the initial exposure length, and the hedged exposure length is longer than the predicted length.

6. The method of claim 1, further comprising:
detecting clipping in the first array of pixels or the second array of pixels, wherein the comparison of the saturation of first array of pixels to the saturation of the second array of pixels is based at least in part on the detected clipping.

7. The method of claim 6, further comprising:
determining that the converged exposure length is equal to the predicted exposure length, or is equal to the hedged exposure length based at least in part on detecting clipping in the first array of pixels or the second array of pixels.

8. The method of claim 1, further comprising:
determining average pixel values in the first array of pixels and the second array of pixels, wherein the comparison of the saturation of the first array of pixels to the saturation of the second array of pixels is based at least in part on the average pixel values.

9. The method of claim 8, further comprising:
determining that the converged exposure length is equal to the predicted exposure length, or is equal to the hedged exposure length based at least in part on the determined average pixel values.

10. The method of claim 3, further comprising:
determining the converged exposure length such that the converged exposure length has an exposure length between the predicted exposure length and the hedged exposure length; and
wherein combining the first array of pixels and the second array of pixels is based at least in part on the determining.

11. The method of claim 10, wherein obtaining the second array of pixels comprises:
applying a digital gain compensation to the first array of pixels.

12. The method of claim 5, wherein the converged exposure length is equal to the predicted exposure length, or is equal to the hedged exposure length.

13. A method for image processing at a device, comprising:
calculating, based at least in part on a clipping status of a set of one or more pixels of a first image frame associated with a first exposure length, an exposure correction direction, a predicted exposure length correction, and a hedged exposure length correction that is greater than the predicted exposure length correction by at least a threshold in the exposure correction direction;
capturing from a sensor a first array of pixels using the predicted exposure length correction and a second array of pixels using the hedged exposure length correction;
selecting a second exposure length based at least in part on a comparison of the first array of pixels to the second array of pixels; and
outputting a second image frame based at least in part on the second exposure length.

14. The method of claim 13, wherein the clipping status of the set of one or more pixels of the first image frame indicates that the first exposure length is underexposed, and wherein the exposure correction direction is an increase in exposure.

15. The method of claim 14, wherein the hedged exposure length correction is overexposed, and wherein capturing the second array of pixels comprises applying a digital gain compensation to the first array of pixels.

16. The method of claim 14, further comprising:
determining that the hedged exposure length is not under-exposed, wherein selecting the second exposure length further comprises setting the second exposure length equal to the hedged exposure length.

17. The method of claim 13, wherein the first array of pixels and the second array of pixels are captured in parallel, and wherein the sensor is a high dynamic range (HDR) sensor capable of supporting multiple exposure lengths.

18. An apparatus for image processing at a device, comprising:
a processor,
memory in electronic communication with the processor; and
instructions stored in the memory and executable by the processor to cause the apparatus to:
capture from a sensor a first image frame using an initial exposure length;
calculate, based at least in part on a clipping status of a set of one or more pixels of the first image frame, a predicted exposure length and a hedged exposure length, wherein the predicted exposure length is different from the hedged exposure length by at least a threshold;
capture from the sensor a first array of pixels using the predicted exposure length and a second array of pixels using the hedged exposure length;
capture from the sensor a second image frame using a converged exposure length, wherein the converged exposure length is based at least in part on a comparison of a saturation of the first array of pixels to a saturation of the second array of pixels; and
output the second image frame.

19. The apparatus of claim 18, wherein the instructions are further executable by the processor to cause the apparatus to:
selectively combine the first array of pixels and the second array of pixels based at least in part on the comparison, wherein outputting the second image frame comprises outputting a combination of the first array of pixels and the second array of pixels.

20. The apparatus of claim 18, wherein the first array of pixels and the second array of pixels are captured in parallel, and wherein the sensor is a high dynamic range (HDR) sensor capable of supporting multiple exposure lengths.
